(19) United States
(12) Patent Application Publication
(10) Pub. No.: US 2014/0046735 A1
(43) Pub. Date: Feb. 13, 2014

(54) EVALUATION VALUE CALCULATION DEVICE, EVALUATION VALUE CALCULATION METHOD, AND COMPUTER PROGRAM PRODUCT

(71) Applicant: Kabushiki Kaisha Toshiba, Tokyo (JP)

(72) Inventors: Masayuki ASHIKAWA, Kanagawa (JP); Yuichi Miyamura, Kanagawa (JP); Michiaki Ariga, Kanagawa (JP)

(73) Assignee: Kabushiki Kaisha Toshiba, Tokyo (JP)

(21) Appl. No.: 13/947,418

(22) Filed: Jul. 22, 2013

(30) Foreign Application Priority Data
Aug. 9, 2012 (JP) 2012-177229

(51) Int. Cl. G06Q 10/06

(52) U.S. Cl. CPC G06Q 10/06395
USPC 705/7.41

(57) ABSTRACT

According to an embodiment, an evaluation value calculation device includes a receiving unit, a first calculator, and a second calculator. The receiving unit is configured to receive, with respect to a task of a worker to input information, a task result indicating the information input by the worker. The first calculator is configured to calculate, in response to receiving the task result, first information including any of an average evaluation value indicating an average value per unit time of an evaluation value given to the worker as compensation for the task, average work time indicating an average value of time necessary to perform one task, and probability information indicating a probability of the task being performed correctly. The second calculator is configured to calculate, using the first information, the evaluation value for the task that is to be performed next by the worker.

### CROSS-REFERENCE TO RELATED APPLICATIONS

This application is based upon and claims the benefit of priority from Japanese Patent Application No. 2012-177229, filed on Aug. 9, 2012; the entire contents of which are incorporated herein by reference.

### FIELD

Embodiments described herein relate generally to an evaluation value calculation device, an evaluation value calculation method, and a computer program product.

### BACKGROUND

When performing a large number of tasks, manually managing all the tasks would be costly. To reduce the cost, a method of automatically performing these tasks becomes necessary, but in order to perform automation, an evaluation value (for example, an amount of payment) to be given to a worker as compensation for a task prepared in advance has to be decided. In recent years, a device for deciding a reward amount for a task is being proposed.

For example, there is known a technique of dividing a job into smaller tasks, and setting an original evaluation point for each task according to the type or value of the task. According to this technique, at a time point of completion of a job, an evaluation point is calculated for each task that a worker has performed, by multiplying an original evaluation point set for the task and the rate of achievement of the task, and a reward amount according to the total evaluation point is decided to be given to the worker.

In the conventional technique, the value of the original evaluation point set for each task is fixed. However, the time it takes to perform a task, the difficulty of the task, and the like are not known until a worker actually performs the task, and the value of the original evaluation point that is set in advance may not be adequate. That is, the conventional technique has a problem that the accuracy of an evaluation value given to a worker as compensation for a task is not sufficient.

### BRIEF DESCRIPTION OF THE DRAWINGS

FIG. 1 is a diagram illustrating an example configuration of an evaluation value calculation device of a first embodiment;

FIG. 2 is a flow chart illustrating an example operation of the evaluation value calculation device of the first embodiment;

FIG. 3 is a flow chart illustrating an example operation of an evaluation value calculation device of a second embodiment;

FIG. 4 is a diagram illustrating an example configuration of an evaluation value calculation device of a third embodiment;

FIG. 5 is a flow chart illustrating an example operation of the evaluation value calculation device of the third embodiment; and

FIG. 6 is a flow chart illustrating an example operation of an evaluation value calculation device of a fourth embodiment.

### DETAILED DESCRIPTION

According to an embodiment, an evaluation value calculation device includes a receiving unit, a first calculator, and a second calculator. The receiving unit is configured to receive, with respect to a task of a worker to input information, a task result indicating the information input by the worker. The first calculator is configured to calculate, in response to receiving the task result, first information including any of an average evaluation value indicating an average value per unit time of an evaluation value given to the worker as compensation for the task, average work time indicating an average value of time necessary to perform one task, and probability information indicating a probability of the task being performed correctly. The second calculator is configured to calculate, using the first information, the evaluation value for the task that is to be performed next by the worker.

Hereinafter, various embodiments will be described in detail with reference to the appended drawings.

### First Embodiment

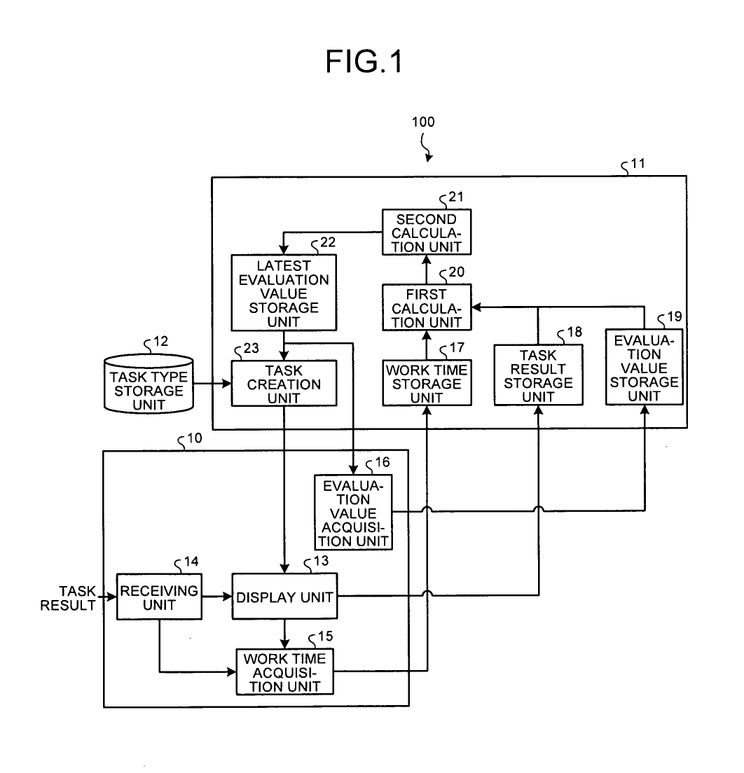

FIG. 1 is a block diagram illustrating an example configuration of an evaluation value calculation device 100 of a first embodiment. As illustrated in FIG. 1, the evaluation value calculation device 100 includes a task execution unit 10, a task management unit 11, and a task type storage unit 12. The task type storage unit 12 stores therein overall task information (including the type of a task, budget and the like).

The task execution unit 10 has a function of displaying a task that is to be performed by a worker, and of receiving input from the worker. In this example, a “task” refers to a task of a worker to input information, and information input by a worker during a task (an input result) is called a “task result”. The task execution unit 10 includes a display unit 13, a receiving unit 14, a work time acquisition unit 15, and an evaluation value acquisition unit 16. Every time a task to be performed next by a worker is created by the task management unit 11 described later, the display unit 13 performs control of displaying second information indicating the created task on a display not illustrated. Then, a worker operates a device such as a mouse or a keyboard, for example, and inputs information regarding the task indicated by the second information displayed by the display unit 13. The receiving unit 14 receives a task result indicating the information input by the worker with respect to the task displayed by the display unit 13.

The work time acquisition unit 15 acquires work time indicating time from a time point of display of the second information to a time point of reception by the receiving unit 14 of input of a task result of a task indicated by the second information. Every time a task result of a task indicated by the second information displayed by the display unit 13 is received by the receiving unit 14, the evaluation value acquisition unit 16 acquires an evaluation value which is compensation for the task indicated by the second information from the task management unit 11 described later.

The task management unit 11 calculates, as first information, an average evaluation value indicating an average value per unit time of the evaluation value given to a worker as compensation for tasks, in response to input of task results received by the task execution unit 10, and calculates an evaluation value for a task that is to be performed next by the worker using the calculated average evaluation value. In the present embodiment, the evaluation value is a sum of money, but this is not restrictive, and the mode of evaluation value is arbitrary. For example, the evaluation value may be a point converted from money, or it may be an experience value indicating that the greater the value the more experienced a worker is. In short, a parameter may be used as the evaluation value, according to which the greater the value, the more advantageous to the worker to whom the value is given. In the following example, the evaluation value is referred to as a “reward amount”.

As illustrated in FIG. 1, the task management unit 11 includes a work time storage unit 17, a task result storage unit 18, an evaluation value storage unit 19, a first calculation unit 20, a second calculation unit 21, a latest evaluation value storage unit 22, and a task creation unit 23.

The work time storage unit 17 stores therein work time acquired by the work time acquisition unit 15. The task result storage unit 18 stores therein a task result received by the receiving unit 14. The evaluation value storage unit 19 stores therein a reward amount (an example of the evaluation value) acquired by the evaluation value acquisition unit 16. The first calculation unit 20 calculates an average reward amount (an average evaluation value) indicating an average value per unit time of the reward amount. The second calculation unit 21 calculates a reward amount for a task that is to be performed next by the worker using the average reward amount calculated by the first calculation unit 20.

Specific details will be given below. In the present embodiment, the first calculation unit 20 calculates an average reward amount indicating the average value of reward amount per one hour, from an accumulated value of work time and a total reward amount indicating an accumulated value of reward amount. More specifically, every time a reward amount acquired by the evaluation value acquisition unit 16 is written to the evaluation value storage unit 19 and work time acquired by the work time acquisition unit 15 is written to the work time storage unit 17 (that is, every time a task is completed), the first calculation unit 20 calculates an average reward amount by dividing the total reward amount indicating the accumulated value of reward amount stored in the evaluation value storage unit 19 at that time point by the accumulated value of work time stored in the work time storage unit 17 at that time point.

The second calculation unit 21 calculates a reward amount for a task that is to be performed next by the worker, using the average reward amount calculated by the first calculation unit 20. More specifically, in the case the average reward amount calculated by the first calculation unit 20 is greater than a first threshold value, the second calculation unit 21 calculates a value smaller than the reward amount for the task immediately preceding the task that is to be performed next by the worker (the latest completed task) as the reward amount for the task that is to be performed next by the worker. On the other hand, in the case the average reward amount is smaller than the first threshold value, a value greater than the reward amount for the task immediately preceding the task that is to be performed next by the worker is calculated as the reward amount for the task that is to be performed next by the worker.

More particularly, in the case the average reward amount calculated by the first calculation unit 20 is greater than the first threshold value, the second calculation unit 21 calculates a value smaller than the reward amount stored in the latest evaluation value storage unit 22 described later at the current time point (which corresponds to the reward amount that is previously calculated, as described later) as the reward amount for the task that is to be performed next by the worker, and updates the reward amount stored in the latest evaluation value storage unit 22 at the current time point to the calculated reward amount. In this case, the reduction rate of the reward amount stored in the latest evaluation value storage unit 22 at the current time point may be made proportional to the difference between the average reward amount calculated by the first calculation unit 20 and the first threshold value, for example. On the other hand, in the case the average reward amount is smaller than the first threshold value, a value greater than the reward amount stored in the latest evaluation value storage unit 22 at the current time point is calculated as the reward amount for the task that is to be performed next by the worker, and the reward amount stored in the latest evaluation value storage unit 22 at the current time point is updated to the calculated reward amount. In this case, the increase rate of the reward amount stored in the latest evaluation value storage unit 22 at the current time point may be made proportional to the difference between the average reward amount calculated by the first calculation unit 20 and the first threshold value, for example.

In this manner, only the latest reward amount calculated by the second calculation unit 21 is stored in the latest evaluation value storage unit 22, and the reward amount stored in the latest evaluation value storage unit 22 is updated to a calculated reward amount every time a reward amount is calculated by the second calculation unit 21.

Every time a reward amount is calculated by the second calculation unit 21, the task creation unit 23 creates a task for which the calculated reward amount serves as compensation (a task associated with the calculated reward amount; here, a task that is to be performed next by the worker). In the present embodiment, the task creation unit 23 creates a task that is to be performed next by the worker from the reward amount stored in the latest evaluation value storage unit 22 and the information stored in the task type storage unit 12. Then, every time a task is created by the task creation unit 23, the display unit 13 displays second information indicating the created task. That is, it is to be understood that every time a reward amount is calculated by the second calculation unit 21, the display unit 13 displays second information indicating a task that is to be performed next by the worker for which the calculated reward amount serves as compensation. Then, every time input of a task result of a task indicated by the second information is received by the receiving unit 14, the evaluation value acquisition unit 16 acquires the reward amount stored in the latest evaluation value storage unit 22 at that time point (a reward amount for the task).

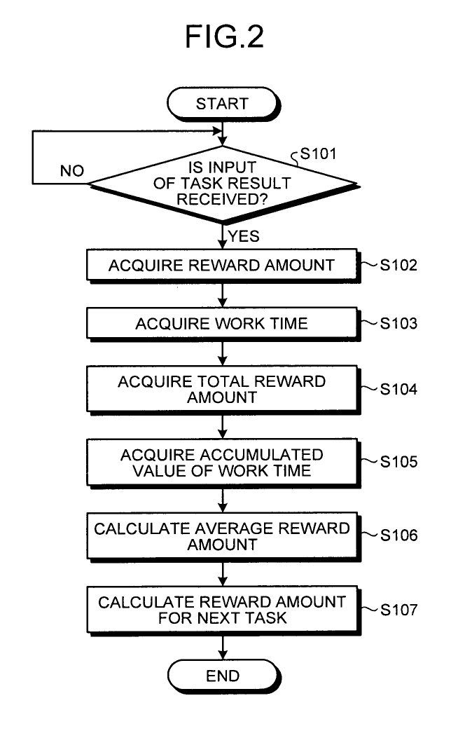

Next, an example operation of the evaluation value calculation device 100 of the present embodiment will be described. FIG. 2 is a flow chart illustrating an example operation of the evaluation value calculation device 100. The example in FIG. 2 is premised on that a new task has been created by the task creation unit 23, and second information indicating the new task is displayed by the display unit 13 (that is, a state where a new task has been set).

In a case where input of a task result indicating the result of the task indicated by the second information displayed by the display unit 13 is received by the receiving unit 14 (a case where the result of step S101 is YES), the evaluation value acquisition unit 16 acquires the reward amount that is stored in the latest evaluation value storage unit 22 at that time point (that is, the reward amount for the task indicated by the second information displayed by the display unit 13) (step S102). The evaluation value acquisition unit 16 writes the acquired reward amount to the evaluation value storage unit 19.

Next, the work time acquisition unit 15 acquires work time indicating the time from a time point of display of the second information to a time point of reception of the input of the task result of the task indicated by the second information (step S103). The work time acquisition unit 15 writes the acquired work time to the work time storage unit 17. Note that the order of step S102 and step S103 may be reversed.

Next, the first calculation unit 20 acquires the total reward amount (including the reward amount acquired in step S102) indicating an accumulated value of reward amount that is stored in the evaluation value storage unit 19 at the time point when the reward amount acquired in step S102 has been written to the evaluation value storage unit 19 (step S104).

Then, the first calculation unit 20 acquires an accumulated value of work time (including the work time acquired in step S103) that is stored in the work time storage unit 17 at the time point when the work time acquired in step S103 has been written to the work time storage unit 17 (step S105). Note that the order of step S104 and step S105 may be reversed.

Next, the first calculation unit 20 calculates an average reward amount by dividing the total reward amount acquired in step S104 by the accumulated value of work time acquired in step S105 (step S106). Then, the second calculation unit 21 calculates a reward amount for the task that is to be performed next by the worker, using the average reward amount calculated in step S106 (step S107). More specifically, in the case the average reward amount calculated by the first calculation unit 20 is greater than a first threshold value, the second calculation unit 21 calculates a value smaller than the reward amount for the task immediately preceding the task that is to be performed next by the worker (the latest completed task) as the reward amount for the task that is to be performed next by the worker. On the other hand, in the case the average reward amount is smaller than the first threshold value, a value greater than the reward amount for the task immediately preceding the task that is to be performed next by the worker is calculated as the reward amount for the task that is to be performed next by the worker.

In the following, a concrete example will be described. In this example, a description is given starting from a state where second information indicating a task ‘input pronunciation of “ [symbol] ”’ is displayed by the display unit 13, and input of text “ [symbol] ” which is the correct task result for the task, is received by the receiving unit 14 (the result of step S101: YES).

In step S102, the evaluation value acquisition unit 16 acquires the reward amount stored in the latest evaluation value storage unit 22. This is assumed to be P1 (yen). Then, the evaluation value acquisition unit 16 writes the acquired reward amount P1 to the evaluation value storage unit 19. Here, it is assumed that the total reward amount stored in the evaluation value storage unit 19 up to then is P2 (yen).

In step S103, the work time acquisition unit 15 acquires work time indicating a difference between the time the second information indicating the task ‘input pronunciation of “ [symbol] ”’ is displayed by the display unit 13 and the time input of the text “ [symbol] ”, which is the task result, is received by the receiving unit 14. This is assumed to be T1 (seconds). Then, the work time acquisition unit 15 writes the acquired work time T1 to the work time storage unit 17. Here, it is assumed that the accumulated value of work time stored in the work time storage unit 17 up to then is T2 (seconds).

In step S104, the first calculation unit 20 acquires the total reward amount P1+P2 (yen) indicating the accumulated value of reward amount that is stored in the evaluation value storage unit 19 at the time point when the reward amount P1 acquired in step S102 has been written to the evaluation value storage unit 19.

In step S105, the first calculation unit 20 acquires the accumulated value of work time T1+T2 (seconds) that is stored in the work time storage unit 17 at the time point when the work time T1 acquired in step S103 has been written to the work time storage unit 17.

In step S106, the first calculation unit 20 calculates an average reward amount P3=(P1+P2)/((T1+T2)/3600) using the total reward amount P1+P2 acquired in step S104 and the accumulated value of work time T1+T2 acquired in step S105. In step S107, the second calculation unit 21 acquires a first threshold value P4 set in advance in the task type storage unit 12 and compares the acquired first threshold value P4 and the average reward amount P3 calculated in step S106, and in the case P3 is greater than P4, the second calculation unit 21 decides that the current average reward amount is high, calculates a value smaller than the reward amount stored in the latest evaluation value storage unit 22 at the current time point as the reward amount for the task that is to be performed next by the worker, and updates the reward amount stored in the latest evaluation value storage unit 22 at the current time point to the calculated reward amount. On the other hand, in the case P3 is smaller than P4, it is decided that the current average reward amount is low, a value greater than the reward amount stored in the latest evaluation value storage unit 22 at the current time point is calculated as the reward amount for the task that is to be performed next by the worker, and the reward amount stored in the latest evaluation value storage unit 22 at the current time point is updated to the calculated reward amount.

As described above, according to the present embodiment, every time input of a task result indicating the result of a task which was set is received, the average reward amount described above is calculated, and the reward amount for the next task is changed according to the calculated average reward amount. More specifically, in the case the average reward amount is greater than the first threshold value, a value smaller than the latest reward amount is calculated as the reward amount for the next task, and in the case the average reward amount is smaller than the first threshold value, a value greater than the latest reward amount is calculated as the reward amount for the next task. For example, the first threshold value may be set to a value that indicates an amount of payment per hour that is set in advance such that the total reward amount when all the tasks have been completed is within the budget. As described above, according to the present embodiment, in the case the calculated average reward amount is greater than the first threshold value, the reward amount for the next task is set to an amount smaller than the reward amount for the immediately preceding task, but in the case the calculated average reward amount is smaller than the first threshold value, the reward amount for the next task is set to a value greater than the reward amount for the immediately preceding task, and thus, it is possible to prevent the total reward amount when all the tasks have been completed from exceeding the budget while preventing the reward amount that is to be paid as compensation for a task from becoming too high or too low (while increasing the accuracy regarding the reward amount).

### Second Embodiment

Next, a second embodiment will be described. Description of parts common with the first embodiment described above will be omitted as appropriate. In the following, the evaluation value calculation device of the second embodiment will be expressed as an “evaluation value calculation device 200”. The basic configuration of the evaluation value calculation device 200 is the same as the configuration illustrated in FIG. 1. Here, for the sake of explanation, each element configuring the evaluation value calculation device 200 (a display unit 13, a receiving unit 14, a work time acquisition unit 15, an evaluation value acquisition unit 16, a work time storage unit 17, a task result storage unit 18, an evaluation value storage unit 19, a first calculation unit 20, a second calculation unit 21, a latest evaluation value storage unit 22, a task creation unit 23, and the like) will be described being denoted with the same reference numeral as in the first embodiment.

A first calculation unit 20 calculates, as first information, average work time indicating the average of time necessary to perform one task, from an accumulated value of work time and an accumulated value of the number of task results received by a receiving unit 14. More specifically, every time a task result received by the receiving unit 14 is written to a task result storage unit 18 and work time acquired by a work time acquisition unit 15 is written to a work time storage unit 17, the first calculation unit 20 calculates the average work time by dividing the accumulated value of work time stored in the work time storage unit 17 at that time point by the accumulated value of the number of task results stored in the task result storage unit 18 at that time point.

Also, a second calculation unit 21 calculates a reward amount for the next task using the average work time calculated by the first calculation unit 20. More specifically, the second calculation unit 21 multiplies the average work time calculated by the first calculation unit 20 and the number of tasks not yet performed, and calculates predicted time indicating a predicted value of time necessary from a current time point until completion of all the tasks. Then, in the case the predicted time is shorter than set time indicating time from a current time point until a task completion time set in advance, the second calculation unit 21 calculates a value smaller than the latest reward amount (the reward amount for the task immediately preceding the next task) as the reward amount for the next task, and in the case the predicted time is longer than the set time, the second calculation unit 21 calculates a value greater than the latest reward amount as the reward amount for the next task.

More particularly, in the case the predicted time is shorter than the set time, the second calculation unit 21 calculates a value smaller than the reward amount stored in a latest evaluation value storage unit 22 at the current time point as the reward amount for the next task, and updates the reward amount stored in the latest evaluation value storage unit 22 at the current time point to the calculated reward amount. In this case, the reduction rate of the reward amount stored in the latest evaluation value storage unit 22 at the current time point may be made proportional to the difference between the predicted time and the set time, for example. On the other hand, in the case the predicted time is longer than the set time, a value greater than the reward amount stored in the latest evaluation value storage unit 22 at the current time point is calculated as the reward amount for the next task, and the reward amount stored in the latest evaluation value storage unit 22 at the current time point is updated to the calculated reward amount. In this case, the increase rate of the reward amount stored in the latest evaluation value storage unit 22 at the current time point may be made proportional to the difference between the predicted time and the set time, for example.

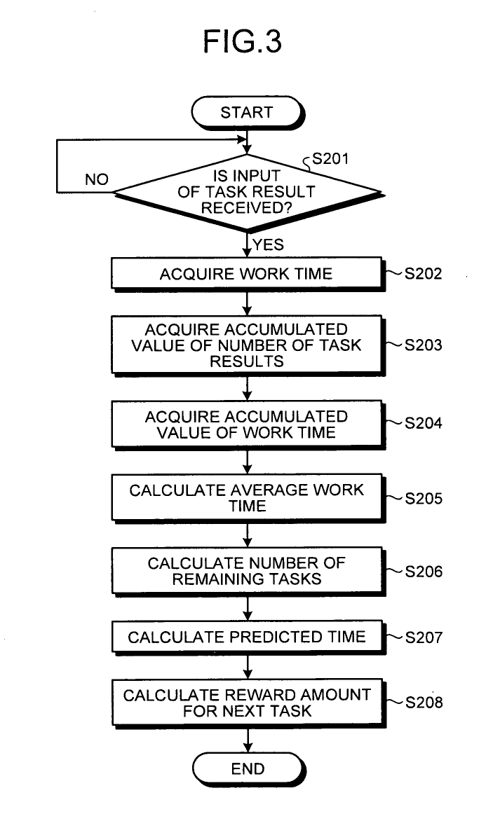

Next, an example operation of the evaluation value calculation device 200 of the second embodiment will be described with reference to FIG. 3. FIG. 3 is a flow chart illustrating an example operation of the evaluation value calculation device 200 of the second embodiment. The example in FIG. 3 is premised on that a new task has been created by a task creation unit 23, and second information indicating the new task is displayed by a display unit 13 (that is, a state where a new task has been set).

In a case where input of a task result indicating the result of the task indicated by the second information displayed by the display unit 13 is received by the receiving unit 14 (a case where the result of step S201 is YES), the received task result is written to the task result storage unit 18.

Next, the work time acquisition unit 15 acquires work time indicating the time from a time point of display of the second information to a time point of reception of the input of the task result of the task indicated by the second information (step S202). Then, the work time acquisition unit 15 writes the acquired work time to the work time storage unit 17.

Then, the first calculation unit 20 acquires an accumulated value of the number of task results that are stored in the task result storage unit 18 at the time point when the task result received in step S201 has been written to the task result storage unit 18 (step S203). Then, the first calculation unit 20 acquires an accumulated value of work time that is stored in the work time storage unit 17 at the time point when the work time acquired in step S202 has been written to the work time storage unit 17 (step S204). Note that the order of step S203 and step S204 may be reversed.

Next, the first calculation unit 20 calculates average work time by dividing the accumulated value of work time acquired in step S204 by the accumulated value of the number of task results acquired in step S203 (step S205).

Next, the second calculation unit 21 calculates the number of remaining tasks (the number of tasks not yet performed) by subtracting the accumulated value of the number of task results acquired in step S203 from the total number of tasks stored in a task type storage unit 12 (step S206). Then, the second calculation unit 21 calculates predicted time indicating a predicted value of time necessary to complete all the tasks by multiplying the average work time calculated in step S205 and the number of remaining tasks calculated in step S206 (step S207). Then, the second calculation unit 21 calculates the reward amount for the next task from the predicted time calculated in step S207 and the set time indicating time from a current time point until a task completion time set in advance (step S208). Specifically, the second calculation unit 21 compares the predicted time calculated in step S207 and the set time, and in the case the predicted time is shorter than the set time, the second calculation unit 21 calculates a value smaller than the reward amount for the task immediately preceding the task that is to be performed next by the worker (the latest completed task) as the reward amount for the task that is to be performed next by the worker. On the other hand, in the case the predicted time is longer than the set time, a value greater than the reward amount for the task immediately preceding the task that is to be performed next by the worker is calculated as the reward amount for the task that is to be performed next by the worker.

In the following, a concrete example will be described. In this example, a description is given starting from a state where second information indicating a task ‘input pronunciation of “ [symbol] ”’ is displayed by the display unit 13, and input of text “ [symbol] ”, which is the correct task result for the task, is received by the receiving unit 14 (the result of step S201: YES). The text “ [symbol] ”, which is the task result received in step S201, is written to the task result storage unit 18. Here, the accumulated value of the number of task results stored in the task result storage unit 18 immediately before the writing of “ [symbol] ”, which is the task result received in step S201, is assumed to be R1 (pieces).

In step S202, the work time acquisition unit 15 acquires work time indicating a difference between the time the second information indicating the task ‘input pronunciation of “ [symbol] ”’ is displayed and the time input of the text “ [symbol] ”, which is the task result, is received by the receiving unit 14. This is assumed to be T3 (seconds). Then, the work time acquisition unit 15 writes the acquired work time T3 to the work time storage unit 17. Here, it is assumed that the accumulated value of work time stored in the work time storage unit 17 immediately before the writing of the work time T3 acquired in step S202 is T4 (seconds).

In step S203, the first calculation unit 20 acquires an accumulated value R1+1 (pieces) of the number of task results that are stored in the task result storage unit 18 at the time point when the text “ [symbol] ”, which is the task result received in step S201, has been written to the task result storage unit 18.

In step S204, the first calculation unit 20 acquires an accumulated value T3+T4 (seconds) of work time that is stored in the work time storage unit 17 at the time point when the work time acquired in step S202 has been written to the work time storage unit 17.

In step S205, the second calculation unit 21 calculates average work time T5=(T3+T4)/(R1+1) using the accumulated value T3+T4 of work time acquired in step S204 and the accumulated value R1+1 of the number of task results acquired in step S203.

In step S206, the second calculation unit 21 acquires the number of remaining tasks (the number of tasks not yet performed) R3=R2−(R1+1) by subtracting the accumulated value R1+1 of the number of task results acquired in step S203 from the total number of tasks R2 stored in the task type storage unit 12.

In step S207, the second calculation unit 21 calculates predicted time T6=R3×T5 indicating a predicted value of time necessary to complete all the tasks by multiplying the number of remaining tasks R3 calculated in step S206 and the average work time T5 calculated in step S205.

In step S208, the second calculation unit 21 acquires a task completion time T7 set in advance (a scheduled task completion time) from the task type storage unit 12, and also a current time T8 from a timer not illustrated, and calculates set time T9=T7−T8 indicating time from the current time T8 to the task completion time T7. Then, in the case T9 is longer than T6, it is decided that the current pace of progress is fast, and the second calculation unit 21 calculates a value smaller than the reward amount stored in the latest evaluation value storage unit 22 at the current time point as the reward amount for the task that is to be performed next by the worker, and updates the reward amount stored in the latest evaluation value storage unit 22. On the other hand, in the case T9 is shorter than T6, it is decided that the current pace of progress is slow, and the second calculation unit 21 calculates a value greater than the reward amount stored in the latest evaluation value storage unit 22 at the current time point as the reward amount for the task that is to be performed next by the worker, and updates the reward amount stored in the latest evaluation value storage unit 22.

As described above, according to the present embodiment, every time input of a task result indicating the result of a task which was set is received, average work time indicating the average of time necessary to perform one task is calculated, and the reward amount for the next task is changed according to the calculated average work time. More specifically, according to the present embodiment, in the case predicted time indicating the result of multiplication of the average work time and the number of tasks not yet performed is shorter than set time indicating the time from a current time point to a task completion time set in advance (that is, in the case the pace of progress is fast), the reward amount for the next task is set to a sum smaller than the reward amount that is stored in the latest evaluation value storage unit 22 at the current time point, but in the case the predicted time is longer than the set time (that is, in the case the pace of progress is slow), the reward amount for the next task is set to a sum greater than the reward amount that is stored in the latest evaluation value storage unit 22 at the current time point.

The present embodiment takes note that the work pace increases when a great reward amount is set and decreases when a small reward amount is set, and in the case the pace of progress is fast, there is room for slowing down the work pace so the reward amount is reduced, whereas in the case the pace of progress is slow, the reward amount is increased because the work pace has to be increased to have all the tasks completed before the task completion time. It is thus possible to have all the tasks completed by the task completion time set in advance, and to set an appropriate reward amount according to the pace of progress (the accuracy regarding the reward amount can be increased).

### Third Embodiment

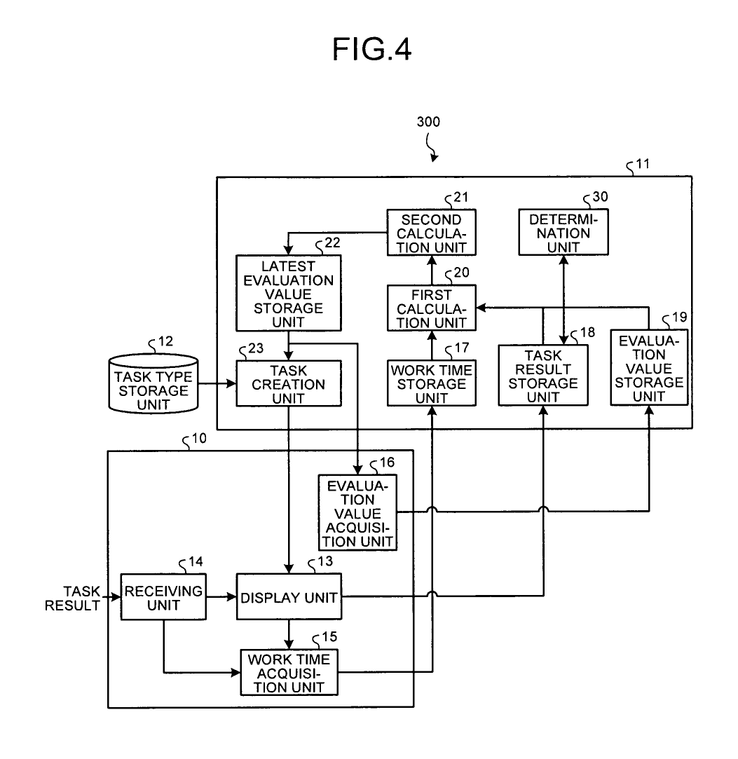

Now, a third embodiment will be described. Description of parts common with the embodiments described above will be omitted as appropriate. FIG. 4 is a diagram illustrating an example configuration of an evaluation value calculation device 300 of the third embodiment. As illustrated in FIG. 4, the evaluation value calculation device 300 is different from the embodiments described above in that a determination unit 30 is further included, but other basic structures are the same as those illustrated in FIG. 1. Here, for the sake of explanation, each element configuring the evaluation value calculation device 300 (elements other than the determination unit 30, i.e. a display unit 13, a receiving unit 14, a work time acquisition unit 15, an evaluation value acquisition unit 16, a work time storage unit 17, a task result storage unit 18, an evaluation value storage unit 19, a first calculation unit 20, a second calculation unit 21, a latest evaluation value storage unit 22, a task creation unit 23, and the like) will be described being denoted with the same reference numeral as in the first embodiment.

Every time a task result received by a receiving unit 14 is written to a task result storage unit 18, the determination unit 30 determines whether the task result which has been written indicates a correct result or not, and stores determination information indicating the determination result (in this example, information of one bit indicating whether or not the result is correct or not) in the task result storage unit 18 in association with the task result which is the target of determination. A method of determining whether a determination target task result indicates a correct result or not may be any method, and, for example, task results of tasks same as the task associated with the determination target task result may be read from the task result storage unit 18, and in the case task results matching the determination target task result make up the majority of the task results which have been read, the determination target task result may be determined to indicate the correct result. Alternatively, information indicating a correct result (“correct answer information”) is stored in advance in a task type storage unit 12, and the determination unit 30 may compare the determination target task result and the correct answer information stored in the task type storage unit 12, and may determine, in the case the determination target task result and the correct answer information match, that the determination target task result indicates a correct result.

In the present embodiment, every time a task result received by the receiving unit 14 is written to the task result storage unit 18, the determination unit 30 determines whether the task result which has been written indicates a correct result. However, this is not restrictive, and, for example, the determination unit 30 may determine, every time input of a task result is received by the receiving unit 14, whether the task result which has been received indicates a correct result or not, and may store determination information indicating the determination result in the task result storage unit 18 in association with the task result which has been received. In short, it is enough if the determination unit 30 includes a function of determining whether a task result received by the receiving unit 14 indicates a correct result or not, and of storing determination information indicating the determination result in the task result storage unit 18 in association with the task result which has been received. That is, the determination unit 30 may perform determination after the task result received by the receiving unit 14 is written to the task result storage unit 18, or before the task result received by the receiving unit 14 is written to the task result storage unit 18.

A first calculation unit 20 calculates probability information indicating the probability of a task being performed correctly, based on a task result received by the receiving unit 14. More specifically, every time determination information for a task result received by the receiving unit 14 is stored in the task result storage unit 18, the first calculation unit 20 calculates the probability information from the determination information for each of all the task results stored in the task result storage unit 18 at the current time point. For example, in the case the number of pieces of determination information, among all the pieces of determination information, indicating a correct result is X1 (pieces) and the number of pieces of determination information indicating an incorrect result is X2 (pieces), the probability information may be expressed as X1/(X1+X2).

A second calculation unit 21 calculates a reward amount for a next task using the probability information calculated by the first calculation unit 20. More specifically, in the case the probability information calculated by the first calculation unit 20 is greater than a second threshold value, the second calculation unit 21 calculates a value smaller than the reward amount for the task immediately preceding the task that is to be performed next by the worker (the latest completed task) as the reward amount for the next task, but in the case the probability information calculated by the first calculation unit 20 is smaller than the second threshold value, the second calculation unit 21 calculates a value greater than the reward amount for the task immediately preceding the task that is to be performed next by the worker (the latest completed task) as the reward amount for the next task.

More particularly, in the case the probability information calculated by the first calculation unit 20 is greater than the second threshold value, the second calculation unit 21 calculates a value smaller than the reward amount stored in a latest evaluation value storage unit 22 at the current time point as the reward amount for the next task, and updates the reward amount stored in the latest evaluation value storage unit 22 to the calculated reward amount. In this case, the reduction rate of the reward amount stored in the latest evaluation value storage unit 22 at the current time point may be made proportional to the difference between the probability information calculated by the first calculation unit 20 and the second threshold value, for example. On the other hand, in the case the probability information calculated by the first calculation unit 20 is smaller than the second threshold value, a value greater than the reward amount stored in the latest evaluation value storage unit 22 at the current time point is calculated as the reward amount for the next task, and the reward amount stored in the latest evaluation value storage unit 22 at the current time point is updated to the calculated reward amount. In this case, the increase rate of the reward amount stored in the latest evaluation value storage unit 22 at the current time point may be made proportional to the difference between the probability information calculated by the first calculation unit 20 and the second threshold value.

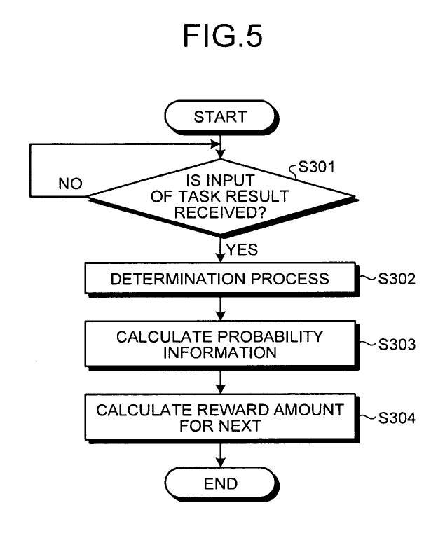

Next, an example operation of the evaluation value calculation device 300 of the third embodiment will be described with reference to FIG. 5. FIG. 5 is a flow chart illustrating an example operation of the evaluation value calculation device 300 of the third embodiment. The example in FIG. 5 is premised on that a new task has been created by a task creation unit 23, and second information indicating the new task is displayed by a display unit 13 (that is, a state where a new task has been set).

In a case where input of a task result indicating the result of the task indicated by the second information displayed by the display unit 13 is received by the receiving unit 14 (a case where the result of step S301 is YES), the received task result is written to the task result storage unit 18.

Next, the determination unit 30 performs a determination process of determining whether the task result received in step S301 indicates a correct result or not (step S302). Then, the determination unit 30 stores determination information indicating the determination result in the task result storage unit 18 in association with the task result received in step S301.

Next, the first calculation unit 20 calculates probability information from the determination information for each of all the task results that are stored in the task result storage unit 18 at the time point when the determination information obtained in step S302 has been stored in the task result storage unit 18 (step S303). Then, the second calculation unit 21 calculates the reward amount for the next task using the probability information calculated in step S303 (step S304). More specifically, in the case the probability information calculated by the first calculation unit 20 is greater than the second threshold value, the second calculation unit 21 calculates a value smaller than the reward amount for the task immediately preceding the task that is to be performed next by the worker (the latest completed task) as the reward amount for the next task, but in the case the probability information calculated by the first calculation unit 20 is smaller than the second threshold value, the second calculation unit 21 calculates a value greater than the reward amount for the task immediately preceding the task that is to be performed next by the worker as the reward amount for the next task.

In the following, a concrete example will be described. In this example, a description is given starting from a state where second information indicating a task ‘input pronunciation of “ [symbol] ”’ is displayed by the display unit 13, and input of text “ [symbol] ”, which is the correct task result for the task, is received by the receiving unit 14 (the result of step S301: YES). The text “ [symbol] ”, which is the task result received in step S301, is written to the task result storage unit 18.

In step S302, the determination unit 30 performs a determination process of determining whether the task result received in step S301 indicates a correct result or not. Then, determination information indicating the determination result is stored in the task result storage unit 18 in association with the task result received in step S301.

In step S303, the first calculation unit 20 acquires all the pieces of determination information that are stored in the task result storage unit 18 at the time point when the determination information obtained in step S302 has been written to the task result storage unit 18, and calculates the probability information from all the pieces of determination information acquired. Here, it is assumed that, among the determination information for each of all the task results that are stored in the task result storage unit 18 at the time point when the determination information obtained in step S302 has been written to the task result storage unit 18, the number of pieces of determination information indicating a correct result is R4 (pieces) and the number of pieces of determination information indicating an incorrect result is R5 (pieces). Accordingly, probability information C1 calculated by the first calculation unit 20 may be expressed as R4/(R4+R5).

In step S304, the second calculation unit 21 compares a second threshold value C2 set in advance in the task type storage unit 12 and the probability information C1 calculated in step S303, and in the case C2 is greater than C1, it is determined that the percentage of being correct is low, that is, that the task is difficult, and the second calculation unit 21 calculates a value greater than the reward amount stored in the latest evaluation value storage unit 22 at a current time point as the reward amount for the task that is to be performed next by the worker, and updates the reward amount stored in the latest evaluation value storage unit 22 at the current time point to the calculated reward amount. On the other hand, in the case C2 is smaller than C1, it is determined that the percentage of being correct is high, that is, that the task is easy, and the second calculation unit 21 calculates a value smaller than the reward amount stored in the latest evaluation value storage unit 22 at the current time point as the reward amount for the task that is to be performed next by the worker, and updates the reward amount stored in the latest evaluation value storage unit 22 at the current time point to the calculated reward amount.

As described above, according to the present embodiment, every time input of a task result indicating the result of a task which was set is received, whether the received task result indicates a correct result or not is determined, and the probability information (information indicating the probability of a task being performed correctly) at that time point is calculated. Then, the reward amount for the next task is changed according to the calculated probability information. Here, with respect to a task that is difficult, since a worker tends to avoid such a task and the work pace tends to decrease, a high reward amount has to be set to increase the work pace. As described above, in the present embodiment, in the case the probability information calculated by the first calculation unit 20 is greater than the second threshold value, it is assumed that the degree of difficulty is high and the reward amount is increased, and in the case the probability information is smaller than the second threshold value, it is assumed that the degree of difficulty is low and the reward amount is reduced. Accordingly, an appropriate reward amount may be set according to the dynamically changing degree of difficulty (the probability information) (the accuracy regarding the reward amount may be increased), and also, a problem of the work pace slowing or a task being left unfinished may be avoided.

### Fourth Embodiment

Now, a fourth embodiment will be described. Description of parts common with the embodiments described above will be omitted as appropriate. In the following, the evaluation value calculation device of the fourth embodiment will be expressed as an “evaluation value calculation device 400”. The basic configuration of the evaluation value calculation device 400 is the same as the configuration illustrated in FIG. 4. Here, for the sake of explanation, each element configuring the evaluation value calculation device 400 (a display unit 13, a receiving unit 14, a work time acquisition unit 15, an evaluation value acquisition unit 16, a work time storage unit 17, a task result storage unit 18, an evaluation value storage unit 19, a first calculation unit 20, a second calculation unit 21, a latest evaluation value storage unit 22, a task creation unit 23, a determination unit 30, and the like) will be described being denoted with the same reference numeral as in the third embodiment.

In the present embodiment, a receiving unit 14 receives, together with input of a task result indicating a result of a task, input of identification information for identifying the worker who has performed the task (the task associated with the task result which has been input). Then, the task result and the identification information received by the receiving unit 14 are written to a task result storage unit 18 in association with each other.

Every time a task result and identification information received by the receiving unit 14 are written to the task result storage unit 18 in association with each other, a determination unit 30 determines whether the task result which has been written indicates a correct result or not, and stores determination information indicating the determination result in the task result storage unit 18 in association with the determination target task result (and the identification information). As in the third embodiment, every time a task result and identification information received by the receiving unit 14 are written to the task result storage unit 18, the determination unit 30 determines whether the task result which has been written indicates a correct result or not. However, this is not restrictive, and the determination unit 30 may determine whether a received task result indicates a correct result or not every time input of a task result and identification information is received by the receiving unit 14, and may store determination information indicating the determination result in the task result storage unit 18 in association with the task result and the identification information which have been received, for example.

A first calculation unit 20 calculates, based on the task result and the identification information received by the receiving unit 14, probability information indicating the probability of the worker identified by the identification information performing a task correctly. More specifically, every time determination information for a task result received by the receiving unit 14 is stored in the task result storage unit 18, the first calculation unit 20 reads the determination information for each of all the task results associated with the identification information with which the determination result (the newly written determination information) is associated from the task result storage unit 18, and calculates probability information for the identification information based on the pieces of determination information which have been read. For example, in the case the number of pieces of determination information indicating a correct result, among the pieces of determination information for all the task results associated with identification information for identifying a worker “A”, is X1 (pieces), and the number of pieces of determination information indicating an incorrect result is X2 (pieces), the probability information associated with the identification information for identifying the worker “A” may be expressed as X1/(X1+X2).

According to the present embodiment, a reward amount is decided separately for each worker identified by the identification information. A second calculation unit 21 separately calculates, for each piece of identification information, a reward amount for the worker identified by the identification information, using the probability information calculated by the first calculation unit 20. More specifically, in the case the probability information calculated by the first calculation unit 20 and associated with a piece of identification information is greater than a third threshold value, the second calculation unit 21 calculates a value greater than the reward amount at the current time point for the worker identified by this identification information as the new reward amount for the worker identified by this identification information, but in the case the probability information is smaller than the third threshold value, the second calculation unit 21 calculates a value smaller than the reward amount at the current time point for the worker identified by this identification information as the new reward amount for the worker identified by this identification information.

More particularly, a latest evaluation value storage unit 22 of the present embodiment stores in association, for each piece of identification information, the latest reward amount calculated by the second calculation unit 21. Then, in the case the probability information calculated by the first calculation unit 20 and associated with a piece of identification information is greater than the third threshold value, the second calculation unit 21 calculates a value greater than the reward amount associated with this identification information and stored in the latest evaluation value storage unit 22 at the current time point as the new reward amount associated with this identification information, and updates the reward amount associated with this identification information and stored in the latest evaluation value storage unit 22 at the current time point to the calculated reward amount. In this case, the increase rate of the reward amount may be made proportional to the difference between the probability information calculated by the first calculation unit 20 and the third threshold value, for example. On the other hand, in the case the probability information calculated by the first calculation unit 20 and associated with a piece of identification information is smaller than the third threshold value, the second calculation unit 21 may calculate a value smaller than the reward amount associated with this identification information and stored in the latest evaluation value storage unit 22 at the current time point as the new reward amount associated with this identification information, and updates the reward amount associated with this identification information and stored in the latest evaluation value storage unit 22 at the current time point to the calculated reward amount. In this case, the reduction rate of the reward amount may be made proportional to the difference between the probability information calculated by the first calculation unit 20 and the third threshold value, for example.

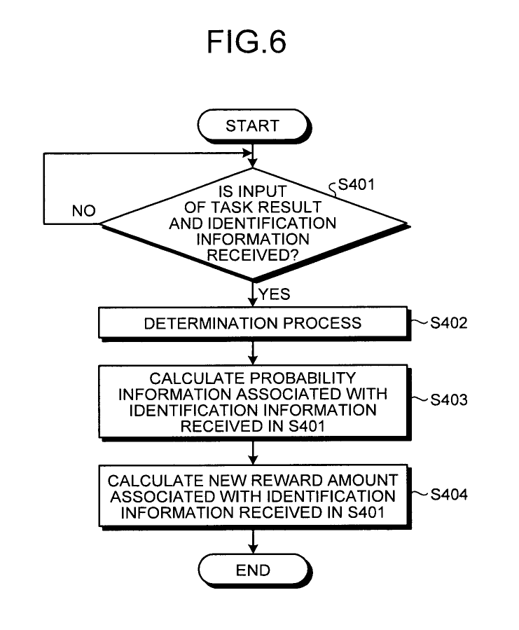

Next, an example operation of the evaluation value calculation device 400 of the fourth embodiment will be described with reference to FIG. 6. FIG. 6 is a flow chart illustrating an example operation of the evaluation value calculation device 400 of the fourth embodiment. The example in FIG. 6 is premised on that a new task has been created by a task creation unit 23, and second information indicating the new task is displayed by a display unit 13 (that is, a state where a new task has been set).

In a case where input of a task result indicating the result of the task indicated by the second information displayed by the display unit 13 and identification information for identifying the worker who has performed the task is received by the receiving unit 14 (a case where the result of step S401 is YES), the task result and the identification information which have been received are written to the task result storage unit 18 in association with each other.

Next, the determination unit 30 performs a determination process of determining whether the task result received in step S401 indicates a correct result or not (step S402). Then, the determination unit 30 stores determination information indicating the determination result in the task result storage unit 18 in association with the task result and the identification information received in step S401.

Next, the first calculation unit 20 reads determination information for each of all the task results associated with the identification information with which the determination information obtained in step S402 is associated from the task result storage unit 18, and calculates probability information associated with the identification information using the pieces of determination information which have been read (step S403).

Next, the second calculation unit 21 calculates a new reward amount associated with the identification information received in step S401 using the probability information calculated in step S403 (step S404). More specifically, in the case the probability information calculated by the first calculation unit 20 and associated with the identification information received in step S401 is greater than the third threshold value, the second calculation unit 21 calculates a value greater than the reward amount associated with the identification information at the current time point (the reward amount associated with the identification information and stored in the latest evaluation value storage unit 22 at the current time point) as the new reward amount associated with the identification information. On the other hand, in the case the probability information calculated by the first calculation unit 20 and associated with the identification information received in step S401 is smaller than the third threshold value, a value smaller than the reward amount associated with the identification information at the current time point (the reward amount associated with the identification information and stored in the latest evaluation value storage unit 22 at the current time point) as the new reward amount associated with the identification information.

In the following, a concrete example will be described. In this example, a description is given starting from a state where second information indicating a task ‘input pronunciation of “ [symbol] ”’ is displayed by the display unit 13, and input of text “ [symbol] ”, which is the correct task result for the task, and identification information (an ID or the like) for identifying the worker who has performed the task is received by the receiving unit 14 (the result of step S401: YES). The text “ [symbol] ”, which is the task result received in step S401, is written to the task result storage unit 18 in association with the identification information received in step S401.

In step S402, the determination unit 30 performs a determination process of determining whether the task result received in step S401 indicates a correct result or not. Then, determination information indicating the determination result is stored in the task result storage unit 18 in association with the task result and the identification information received in step S401.

In step S403, the first calculation unit 20 reads, from the task result storage unit 18, determination information for each of all the task results associated with the identification information received in step S401 and stored in the task result storage unit 18 at the time point when the determination information obtained in step S402 has been written to the task result storage unit 18, and calculates the probability information associated with the identification information using the pieces of determination information which have been read. Here, it is assumed that, among the pieces of determination information for all the task results associated with the identification information received in step S401 and stored in the task result storage unit 18 at the time point when the determination information obtained in step S402 has been written to the task result storage unit 18, the number of pieces of determination information indicating a correct result is R6 (pieces) and the number of pieces of determination information indicating an incorrect result is R7 (pieces). Accordingly, probability information C3 calculated by the first calculation unit 20 and associated with the identification information received in step S401 may be expressed as R6/(R6+R7).

In step S404, the second calculation unit 21 compares a third threshold value C4 set in advance in the task type storage unit 12 and the probability information C3 calculated in step S403, and in the case C4 is greater than C3, it is determined that the percentage of being correct is low, that is, that the accuracy of the worker is low, and the second calculation unit 21 calculates a value smaller than the reward amount for the worker (the identification information) stored in the latest evaluation value storage unit 22 at the current time point as the new reward amount for the worker, and updates the reward amount for the worker stored in the latest evaluation value storage unit 22 at the current time point to the calculated reward amount. On the other hand, in the case C3 is greater than C4, it is determined that the percentage of being correct is high, that is, that the accuracy of the worker is high, and a value greater than the reward amount for the worker stored in the latest evaluation value storage unit 22 at the current time point is calculated as the new reward amount for the worker, and the reward amount for the worker stored in the latest evaluation value storage unit 22 at the current time point is updated to the calculated reward amount.

As described above, according to the present embodiment, every time input of a task result indicating the result of a task which was set and the identification information for identifying the worker who has performed the task is received, whether the received task result indicates a correct result or not is determined, and the probability information (information indicating the probability of a task being performed correctly) associated with the identification information is calculated. Then, the reward amount for the worker identified by the identification information is changed according to the probability information associated with the identification information. More specifically, in the case the calculated probability information is greater than the third threshold value, it is determined that the accuracy of the worker is high, and the reward amount is increased, and in the case the calculated probability information is smaller than the third threshold value, it is determined that the accuracy of the worker is low, and the reward amount is decreased. Accordingly, a reward amount fitting the performance of a worker may be set for each worker (that is, the accuracy regarding the reward amount may be increased). Also, if the reward amount for a highly accurate worker is increased, the highly accurate worker may be motivated and will willingly work on a task, which will increase the number of tasks performed by the highly accurate worker, and the overall accuracy of tasks will be increased.

Embodiments of the present invention have been described above, but each embodiment described above is only an example, and is not to limit the scope of the invention. These new embodiments may be carried out in various other modes, and various omissions, substitutions and changes may be made without departing from the spirit of the invention. These embodiments and modifications fall within the scope and the spirit of the invention, and also, within the invention described in the accompanying claims and their equivalents.

The first calculation unit 20 described above calculates, in the first embodiment, in response to receiving a task result, an average reward amount indicating an average value per unit time of reward amount to be given to a worker as compensation for a task, calculates, in the second embodiment, in response to receiving a task result, average work time indicating an average value of time necessary to perform one task, and calculates, in the third and fourth embodiments, in response to receiving a task result, probability information indicating the probability of a task being performed correctly. In short, it is enough if the first calculation unit of the present invention calculates, in response to receiving a task result, first information including any of an average evaluation value indicating an average value per unit time of an evaluation value to be given to a worker as compensation for a task, average work time indicating an average value of time necessary to perform one task, and probability information indicating the probability of a task being performed correctly.

For example, a computer including a CPU, a ROM, a RAM and the like may be mounted on the evaluation value calculation device described above, and at least one of the functions of the units described above (the display unit 13, the receiving unit 14, the work time acquisition unit 15, the evaluation value acquisition unit 16, the first calculation unit 20, the second calculation unit 21, the task creation unit 23, and the determination unit 30) may be realized by the CPU developing a program stored in the ROM or the like on the RAM and executing the program. Also, for example, at least one of the functions of the units described above (the display unit 13, the receiving unit 14, the work time acquisition unit 15, the evaluation value acquisition unit 16, the first calculation unit 20, the second calculation unit 21, the task creation unit 23, and the determination unit 30) may be realized by a dedicated hardware circuit.

Additionally, the embodiments described above may be arbitrarily combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An evaluation value calculation device comprising:
a receiving unit configured to receive, with respect to a task of a worker to input information, a task result indicating the information input by the worker;
a first calculator configured to calculate, in response to receiving the task result, first information including any of an average evaluation value indicating an average value per unit time of an evaluation value given to the worker as compensation for the task, average work time indicating an average value of time necessary to perform one task, and probability information indicating a probability of the task being performed correctly; and
a second calculator configured to calculate, using the first information, the evaluation value for the task that is to be performed next by the worker.

2. The device according to claim 1, wherein
the first calculator calculates the average evaluation value as the first information, from an accumulated value of work time and an accumulated value of the evaluation value calculated by the second calculator, and
when the average evaluation value is greater than a first threshold value, the second calculator calculates a value smaller than the evaluation value for the task immediately preceding the task that is to be performed next by the worker as the evaluation value for the task that is to be performed next by the worker, but when the average evaluation value is smaller than the first threshold value, the second calculator calculates a value greater than the evaluation value for the task immediately preceding the task that is to be performed next by the worker as the evaluation value for the task that is to be performed next by the worker.

3. The device according to claim 2, further comprising:
a display unit configured to display, every time the evaluation value is calculated by the second calculator, second information indicating the task that is to be performed next by the worker;
an evaluation value acquisition unit configured to acquire, when the receiving unit receives the task result of the task indicated by the second information, the evaluation value for the task indicated by the second information;
an evaluation value storage unit configured to cumulatively store therein the evaluation value thus acquired, every time the evaluation value is acquired by the evaluation value acquisition unit;
a work time acquisition unit configured to acquire work time indicating time from a time point of display of the second information to a time point of reception by the receiving unit of the task result of the task indicated by the second information; and
a work time storage unit configured to store therein the work time, wherein
every time the evaluation value acquired by the evaluation value acquisition unit is written to the evaluation value storage unit and the work time acquired by the work time acquisition unit is written to the work time storage unit, the first calculator calculates the average evaluation value by dividing an accumulated value of the evaluation value stored in the evaluation value storage unit at that time point by an accumulated value of the work time stored in the work time storage unit at that time point.

4. The device according to claim 3, further comprising:
a latest evaluation value storage unit configured to store therein a latest evaluation value calculated by the second calculator, wherein
when the receiving unit receives the task result of the task indicated by the second information, the evaluation value acquisition unit acquires the evaluation value stored in the latest evaluation value storage unit at that time point, and
when the average evaluation value is greater than the first threshold value, the second calculator calculates a value smaller than the evaluation value stored in the latest evaluation value storage unit at a current time point as the evaluation value for the task that is to be performed next by the worker, and updates the evaluation value stored in the latest evaluation value storage unit at the current time point to the calculated evaluation value, but when the average evaluation value is smaller than the first threshold value, the second calculator calculates a value greater than the evaluation value stored in the latest evaluation value storage unit at a current time point as the evaluation value for the task that is to be performed next by the worker, and updates the evaluation value stored in the latest evaluation value storage unit at the current time point to the calculated evaluation value.

5. The device according to claim 1, wherein
the first calculator calculates the average work time as the first information, from an accumulated value of work time and an accumulated value of the number of task results received by the receiving unit, and
the second calculator calculates predicted time indicating a predicted value of time necessary from a current time point to completion of all the tasks by multiplying the average work time and the number of tasks not yet performed, and
when the predicted time is shorter than set time indicating time from a current time point until a task completion time set in advance, the second calculator calculates a value smaller than the evaluation value for the task immediately preceding the task that is to be performed next by the worker as the evaluation value for the task that is to be performed next by the worker, but when the predicted time is longer than the set time, the second calculator calculates a value greater than the evaluation value for the task immediately preceding the task that is to be performed next by the worker as the evaluation value for the task that is to be performed next by the worker.

6. The device according to claim 5, further comprising:
a display unit configured to display, every time the evaluation value is calculated by the second calculator, second information indicating the task that is to be performed next by the worker;
a work time acquisition unit that acquires work time indicating time from a time point of display of the second information to a time point of reception by the receiving unit of the task result of the task indicated by the second information;
a work time storage unit configured to store therein the work time; and
a task result storage unit configured to store therein the task result received by the receiving unit, wherein
every time the task result received by the receiving unit is written to the task result storage unit and the work time acquired by the work time acquisition unit is written to the work time storage unit, the first calculator calculates the average work time by dividing an accumulated value of the work time stored in the work time storage unit at that time point by an accumulated value of the number of task results stored in the task result storage unit at that time point.

7. The device according to claim 6, further comprising:
a latest evaluation value storage unit configured to store therein a latest evaluation value calculated by the second calculator, wherein
when the predicted time is shorter than the set time, the second calculator calculates a value smaller than the evaluation value stored in the latest evaluation storage unit at a current time point as the evaluation value for the task that is to be performed next by the worker, and updates the evaluation value stored in the latest evaluation value storage unit at the current time point to the calculated evaluation value, but when the predicted time is longer than the set time, the second calculator calculates a value greater than the evaluation value stored in the latest evaluation value storage unit at a current time point as the evaluation value for the task that is to be performed next by the worker, and updates the evaluation value stored in the latest evaluation value storage unit at the current time point to the calculated evaluation value.

8. The device according to claim 1, wherein
the first calculator calculates the probability information as the first information, based on the task result received by the receiving unit, and
when the probability information is greater than a second threshold value, the second calculator calculates a value smaller than the evaluation value for the task immediately preceding the task that is to be performed next by the worker as the evaluation value for the task that is to be performed next by the worker, but when the probability information is smaller than the second threshold value, the second calculator calculates a value greater than the evaluation value for the task immediately preceding the task that is to be performed next by the worker as the evaluation value for the task that is to be performed next by the worker.

9. The device according to claim 8, further comprising:
a task result storage unit configured to store therein the task result received by the receiving unit; and
a determination unit configured to determine whether the task result received by the receiving unit indicates a correct result or not, and store determination information indicating a determination result in the task result storage unit in association with the task result, wherein
every time the determination information is stored in the task result storage unit, the first calculator calculates the probability information from the determination information for each of all task results stored in the task result storage unit at that time point.

10. The device according to claim 9, further comprising:
a latest evaluation value storage unit configured to store therein a latest evaluation value calculated by the second calculator, wherein
when the probability information calculated by the first calculator is greater than the second threshold value, the second calculator calculates a value smaller than the evaluation value stored in the latest evaluation storage unit at a current time point as the evaluation value for the task that is to be performed next by the worker, and updates the evaluation value stored in the latest evaluation value storage unit at the current time point to the calculated evaluation value, but when the probability information calculated by the first calculator is smaller than the second threshold value, the second calculator calculates a value greater than the evaluation value stored in the latest evaluation value storage unit at a current time point as the evaluation value for the task that is to be performed next by the worker, and updates the evaluation value stored in the latest evaluation value storage unit at the current time point to the calculated evaluation value.

11. The device according to claim 1, wherein
the receiving unit receives, together with input of the task result, input of identification information for identifying the worker who has performed the task associated with the task result,
the first calculator calculates, as the first information, the probability information indicating a probability of the worker identified by the identification information performing the task correctly, based on the task result received by the receiving unit and the identification information for identifying the worker who has performed the task associated with the task result, and
the second calculator separately calculates, for each piece of the identification information, the evaluation value for the worker identified by the identification information, using the probability information associated with the identification information.

12. The device according to claim 11, wherein when the probability information associated with the identification information is greater than a third threshold value, the second calculator calculates a value greater than the evaluation value at a current time point for the worker identified by the identification information as a new evaluation value for the worker identified by the identification information, but the probability information is smaller than the third threshold value, the second calculator calculates a value smaller than the evaluation value at the current time point for the worker identified by the identification information as the new evaluation value for the worker identified by the identification information.

13. The device according to claim 11, further comprising:
a task result storage unit configured to store therein the task result and the identification information received by the receiving unit in association with each other; and
a determination unit configured to determine whether the task result received by the receiving unit indicates a correct result or not, and store determination information indicating a determination result in the task result storage unit in association with the task result and the identification information, wherein
every time the determination information is stored in the task result storage unit, the first calculator reads, from the task result storage unit, the determination information for each of all the tasks associated with the identification information with which the determination information is associated, and calculates the probability information associated with the identification information using the determination information which has been read.

14. The device according to claim 13, further comprising:
a latest evaluation value storage unit configured to store therein, for each piece of the identification information, a latest evaluation value calculated by the second calculation unit in association, wherein
when the probability information calculated by the first calculator and associated with the identification information is greater than the third threshold value, the second calculator calculates a value greater than the evaluation value associated with the identification information and stored in the latest evaluation value storage unit at a current time point as a new evaluation value for the worker identified by the identification information, and updates the evaluation value associated with the identification information and stored in the latest evaluation value storage unit to the calculated evaluation value, but when the probability information calculated by the first calculator and associated with the identification information is smaller than the third threshold value, the second calculator calculates a value smaller than the evaluation value associated with the identification information and stored in the latest evaluation value storage unit at a current time point as a new evaluation value for the worker identified by the identification information, and updates the evaluation value associated with the identification information and stored in the latest evaluation value storage unit to the calculated evaluation value.

15. An evaluation value calculation method comprising:
receiving, with respect to a task of a worker to input information, a task result indicating the information input by the worker;
calculating, in response to receiving the task result, first information including any of an average evaluation value indicating an average value per unit time of an evaluation value given to the worker as compensation for the task, average work time indicating an average value of time necessary to perform one task, and probability information indicating a probability of the task being performed correctly; and
calculating, using the first information, the evaluation value for the task that is to be performed next by the worker.

16. A computer program product comprising a computer readable medium containing an evaluation value calculation program, the program causing a computer to execute:
receiving, with respect to a task of a worker to input information, a task result indicating the information input by the worker;
calculating, in response to receiving the task result, first information including any of an average evaluation value indicating an average value per unit time of an evaluation value given to the worker as compensation for the task, average work time indicating an average value of time necessary to perform one task, and probability information indicating a probability of the task being performed correctly; and
calculating, using the first information, the evaluation value for the task that is to be performed next by the worker.
